(19) United States
(12) Patent Application Publication
(10) Pub. No.: US 2009/0092870 A1
(43) Pub. Date: Apr. 9, 2009

(54) FUEL CELL SYSTEM

(76) Inventors: Tomohiro Ogawa, Shizuoka-ken (JP); Yasushi Araki, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/282,357

(22) PCT Filed: Mar. 30, 2007
(86) PCT No.: PCT/JP2007/057177

§ 371 Date: Sep. 10, 2008

(30) Foreign Application Priority Data
Apr. 11, 2006 (JP) 2006-109073

(51) Int. Cl. H01M 8/04; H01M 8/10

(52) U.S. Cl. 429/22

(57) ABSTRACT

To provide a fuel cell system of dead end type capable of generating power with high efficiency. A fuel cell system 1 has a fuel cell 2 and pressure controlling means 9 that controls the pressure of a fuel gas. The fuel cell 2 is operated in a state where a channel 10 for a fuel off-gas is closed. When a predetermined time elapses, the channel 10 is opened for purging. The pressure controlling means 9 sets the pressure of the fuel gas at P₁ from a point in time immediately after purging to a time t₁ and sets the pressure of the fuel gas at P₂, which is higher than P₁, when the time t₁ elapses.

### TECHNICAL FIELD

The present invention relates to a fuel cell system.

### BACKGROUND ART

A fuel cell has an anode and a cathode that are disposed with an electrolyte membrane interposed therebetween. When a reactant gas is supplied to the electrodes, an electrochemical reaction occurs between the electrodes to generate an electromotive force. More specifically, the reaction occurs when hydrogen (fuel gas) comes into contact with the anode and oxygen (oxidant gas) comes into contact with the cathode.

In general, the anode is supplied with hydrogen from a high-pressure hydrogen reservoir. On the other hand, the cathode is supplied with air taken in from the atmosphere with a compressor. To improve the power and hydrogen utilization of the fuel cell, the fuel off-gas discharged from the fuel cell is recycled to the fuel cell.

However, there is a problem: if a pump for recycling the fuel off-gas from the fuel cell fails, hydrogen can not be supplied to the anode, and therefore, it is difficult to continue the operation of the fuel cell.

To avoid the problem, there has been proposed a fuel cell system that closes the recycling path for the fuel off-gas to confine the fuel off-gas in the closed path when a failure of a pump is detected (see Patent Document 1). In the fuel cell system, the mode of supply of hydrogen to the anode is switched from the circuit mode to the so-called dead end mode. Therefore, the anode is supplied with an amount of hydrogen equal to the amount of hydrogen consumed at the anode, so that the fuel cell can continue to operate even if a pump fails.

Patent Document 1: Japanese Patent Laid-Open No. 2005-32652

Patent Document 1: Japanese Patent Laid-Open No. 2003-77506

### DISCLOSURE OF THE INVENTION

### Problem to be Solved by the Invention

In the dead end mode, power generation is carried out in a state where the downstream part of the hydrogen channel on the anode side is closed (such a state will be referred to also as closed mode, hereinafter).

According to the Patent Document 1, in the dead end mode, materials other than hydrogen increase at the outlet of the hydrogen channel, so that the partial pressure of hydrogen decreases, and the voltage of the fuel cell decreases. To avoid this, the operating condition of the fuel cell is changed, or the fuel cell system is controlled in a variable manner so that the power is limited in operation.

Specifically, the operating condition of the fuel cell is set so that the operating pressure of the fuel cell is higher than that in operation in the circuit mode, and accordingly, the operation of means for supplying reactant gases to the anode and the cathode is controlled. As a result, the pressure of hydrogen supplied to the anode is raised, and therefore, the pressure of hydrogen can be maintained at high level even if proportions of materials other than hydrogen increase.

As a result, even if proportions of materials other than hydrogen (impurity materials) in the hydrogen channel increase, a decrease in voltage is suppressed, and power generation in the dead end mode can be continued.

However, there remains a problem that, if the pressure of hydrogen raised, the amount of hydrogen that permeates through the electrolyte membrane to the cathode side increases, and therefore, the hydrogen utilization decreases. It is demanded that the power generation efficiency in the dead end mode is improved not only by preventing the decrease in voltage described above but also by addressing the decrease of the hydrogen utilization.

The present invention has been devised in view of such problems. Specifically, the present invention provides a fuel cell system of dead end type that is capable of generating power with high efficiency.

Other objects and advantages of the present invention will be apparent from the following description.

### Means for Solving the Problem

A fuel cell system according to the present invention comprises:

a fuel cell that has an electrolyte membrane, an anode disposed on one surface of the electrolyte membrane, and a cathode disposed on the other surface of the electrolyte membrane and is supplied with a fuel gas at the anode and with an oxidant gas at the cathode to generate an electromotive force; and

pressure controlling means that controls the pressure of said fuel gas,

in which the fuel cell system has a closed mode in which said fuel cell is operated in a state where a channel for a fuel off-gas discharged from said fuel cell is closed, and

said pressure controlling means sets the pressure of said fuel gas at P₁ from the start of operation in said closed mode until a time t₁ elapses and sets the pressure of said fuel gas at P₂ (P₁<P₂) after the time t₁ elapses.

The fuel cell system according to the present invention further comprises:

purge means that opens the channel for said fuel off-gas to purge the channel,

and, when said purge means carries out purging, it can be determined that said closed mode starts immediately after the purging.

In the fuel cell system according to the present invention, the pressure controlling means can increase the pressure P₂ stepwise.

In the fuel cell system according to the present invention, the pressure controlling means can increase the pressure P₂ continuously.

In the fuel cell system according to the present invention, supposing that the sum of total loss of power generated by said fuel cell due to a decrease in voltage of said fuel cell and said total loss of power due to permeation of said fuel gas through said electrolyte membrane when pressure is P₁ is designated as X₁, and the sum of said total loss of power due to a decrease in voltage of said fuel cell and said total loss of power due to permeation of said fuel gas through said electrolyte membrane when pressure is P₂ is designated as X₂, a relation:

X₂<X₁

preferably holds after the time t₁ elapses.

In the fuel cell system according to the present invention, the pressure P₁ is a pressure that allows a minimum amount of fuel gas required for said fuel cell to generate power to be supplied to said anode, and

the time t₁ can correspond to a time coordinate in a graph whose coordinate axes are time and total loss of power generated by said fuel cell at which a first curve, which shows the sum of a change in said total loss of power due to a decrease in voltage of said fuel cell and a change in said total loss of power due to permeation of said fuel gas through said electrolyte membrane when pressure is P₁, and a second curve, which shows the sum of a change in said total loss of power due to a decrease in voltage of said fuel cell and a change in said total loss of power due to permeation of said fuel gas through said electrolyte membrane when pressure is P₂, intersect with each other.

In the fuel cell system according to the present invention, when a time t₂ (t₁<t₂) elapses, the pressure of said fuel gas can be set at P₃ (P₂<P₃), and the channel for said fuel off-gas can be opened to carry out purging. In this case, the pressure P₃ preferably is a pressure that is high enough to adequately discharge an impurity gas accumulated in the channel for said fuel off-gas.

### EFFECTS OF THE INVENTION

The fuel cell system according to the present invention can generate power with high efficiency because the pressure of the fuel gas is set at P₁ from the start of the closed mode to the time t₁, and the pressure of the fuel gas is changed to P₂ (P₁<P₂) when the time t₁ elapses.

### BRIEF DESCRIPTION OF THE DRAWINGS

FIG. 1 is a diagram showing a configuration of a fuel cell system according to an embodiment 1 of the present invention;

FIG. 2 is a schematic cross-sectional view of a cell constituting a fuel cell according to the embodiment 1;

FIG. 3 is a graph showing temporal changes in total loss of power due to a decrease in voltage in the embodiment 1;

FIG. 4 is a graph showing temporal changes in total loss of power due to permeation of hydrogen in the embodiment 1;

FIG. 5 is a graph showing temporal changes in total loss of power due to the decrease in voltage and the permeation of hydrogen in the embodiment 1;

FIG. 6(a) is a graph showing an example of the way of changing with time the pressure of hydrogen supplied to an anode in the embodiment 1;

FIG. 6(b) is a graph showing a temporal change in voltage of the fuel cell in the case shown in FIG. 6(a);

FIG. 7 is a graph showing another example of the way of changing with time the pressure of hydrogen supplied to the anode in the embodiment 1;

FIG. 8 is a graph showing another example of the way of changing with time the pressure of hydrogen supplied to the anode in the embodiment 1; and

FIG. 9 is a graph showing a temporal change in voltage of a fuel cell of a conventional fuel cell system.

### DESCRIPTION OF NOTATIONS

1 fuel cell system
2 fuel cell
3 compressor
4 humidifier
5 air pressure regulating valve
6 hydrogen reservoir
7 hydrogen pressure regulating valve
8 purge valve
9 pressure controlling means
10 channel
11 cell
12 membrane electrode gas diffusion layer assembly
13,14 separator
15 electrolyte membrane
16 anode
17 cathode
18,19 gas diffusion layer

### BEST MODE FOR CARRYING OUT THE INVENTION

### Embodiment 1

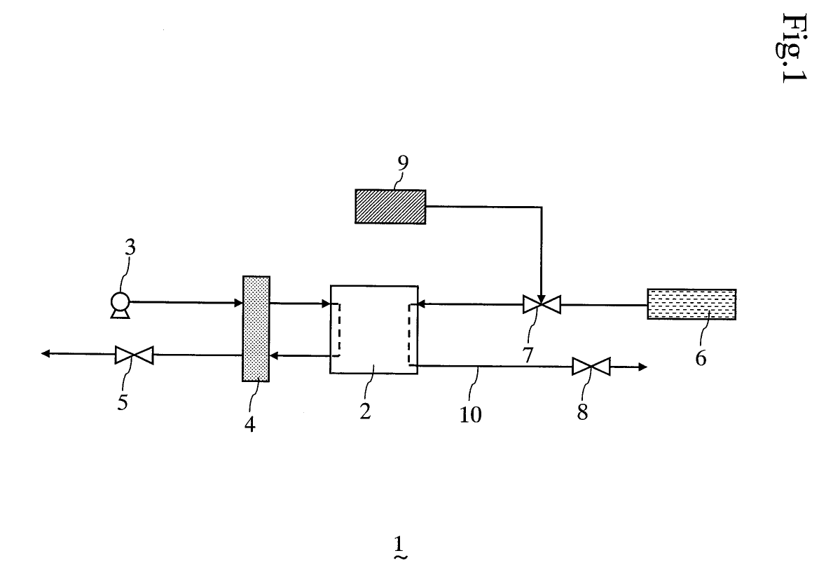

FIG. 1 is a schematic diagram showing a fuel cell system according to an embodiment 1 of the present invention. It is to be noted that the fuel cell system has various applications, such as on-vehicle type and stationary type.

As shown in FIG. 1, a fuel cell system 1 comprises a fuel cell 2 that is supplied with hydrogen as a fuel gas and air as an oxidant gas to generate an electromotive force, a compressor 3 that supplied compressed air to the fuel cell 2, a humidifier 4 that collects moisture from oxidant off-gas discharged from the fuel cell 2 and humidifies the air supplied to the fuel cell 2, an air pressure regulating valve 5 that regulates the pressure of the air supplied to the fuel cell 2 from the compressor 3, a hydrogen reservoir 6 that stores dry hydrogen at a high pressure, a hydrogen pressure regulating valve 7 that regulates the pressure of the hydrogen supplied to the fuel cell 2 from the hydrogen reservoir 6, a purge valve 8 that opens and closes a channel 10 for fuel off-gas, and pressure controlling means 9 that controls the pressure of the hydrogen by changing the opening of the hydrogen pressure regulating valve 7. The fuel off-gas discharged form the fuel cell 2 can be purged by opening the purge valve 8.

In the fuel cell system 1, hydrogen is supplied to an anode (not shown) in the dead end mode. That is, when the purge valve 8 is closed, the channel for the fuel off-gas is closed, and hydrogen is supplied only from the hydrogen reservoir 6. In the dead end mode, the hydrogen supplied is completely consumed in the reaction in the fuel cell 2. Then, only an amount of hydrogen equal to the amount of hydrogen consumed is supplied to the anode.

The fuel cell 2 is a polymer electrolyte fuel cell. However, the present invention is not limited thereto, and an alkaline fuel cell can also be used, for example.

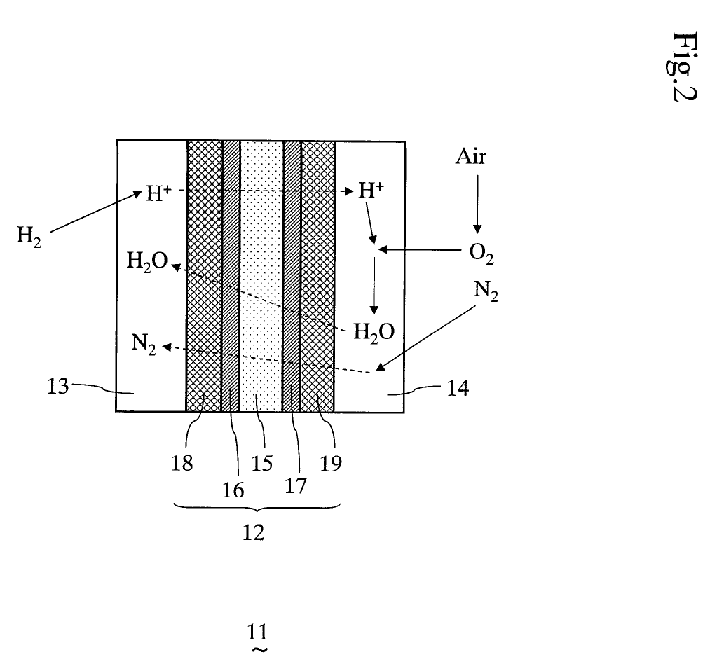

FIG. 2 is a schematic cross-sectional view of a cell constituting the fuel cell 2. As shown in this drawing, a cell 11 comprises a stack of a membrane electrode gas diffusion layer assembly (MEGA) 12 and separators 13, 14 in which a channel for a reactant gas is formed. The membrane electrode gas diffusion layer assembly 12 comprises an electrolyte membrane 15 of a solid polymer, an anode 16 constituted by a catalyst layer formed on one surface of the electrolyte membrane 15, a cathode 17 constituted by a catalyst layer formed on the other surface of the electrolyte membrane 15, and gas diffusion layers 18 and 19 formed on the anode side and the cathode side, respectively. The separators 13 and 14 are disposed on the anode 16 and the cathode 17 with the gas diffusion layers 18 and 19 interposed therebetween, respectively.

When hydrogen is supplied to the anode 16, a reaction:

H₂→2H⁺+2e⁻

occurs, and H⁺ are produced. The H⁺ move to the cathode side through the electrolyte membrane 15 and react with oxygen supplied to the cathode 17 as described below.

(½)O₂+2H⁺+2e⁻→H₂O

That is, an electrochemical reaction:

H₂+(½)O₂→H₂O

occurs between the electrodes to produce an electromotive force. In this process, water is produced on the cathode side. The produced water permeates through the electrolyte membrane 15 and also is accumulated on the anode side.

The air supplied to the cathode 17 also contains nitrogen. The nitrogen also permeates through the electrolyte membrane 15 and is accumulated on the anode side.

Therefore, during operation of the fuel cell 2, water and nitrogen are accumulated in the channel 10 on the anode side in FIG. 1. As a result, the partial pressure of hydrogen decreases, and the voltage of the fuel cell 2 decreases.

According to this embodiment, in order to suppress the reduction of the voltage of the fuel cell 2, when a predetermined time elapses from the start of operation, the pressure of hydrogen supplied to the anode 16 is raised. However, if the pressure of hydrogen is raised, the amount of hydrogen that permeates through the electrolyte membrane 15 increases, and therefore the utilization of hydrogen decreases. Thus, it is preferred that the pressure of hydrogen supplied to the anode 16 and the timing of raising the hydrogen pressure are determined taking into account both the decrease in voltage of the fuel cell 2 and the decrease in hydrogen utilization.

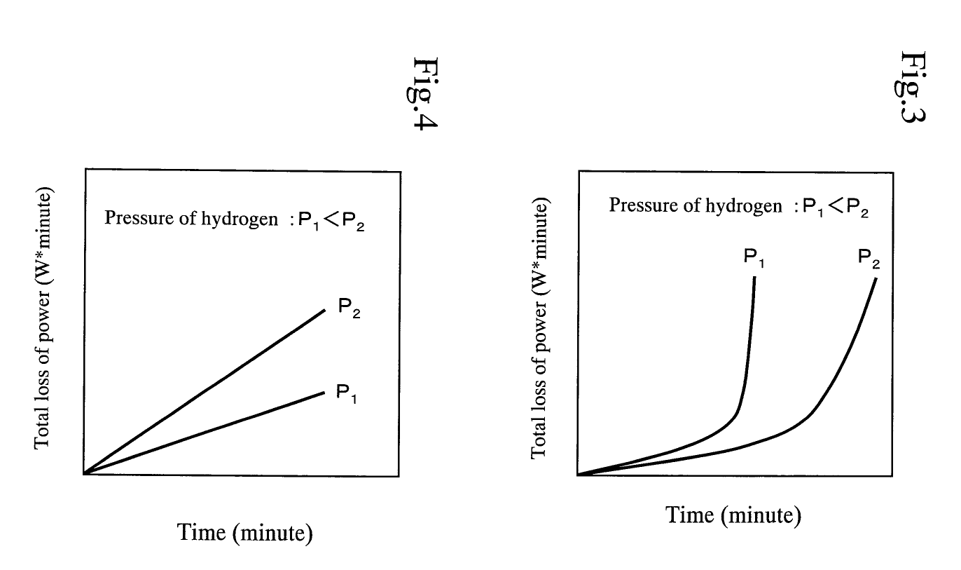

FIG. 3 is a graph schematically showing temporal changes in total loss of power due to a decrease in voltage of the fuel cell.

Factors that affect the decrease in voltage of the fuel cell of dead end type include the amount of permeation of water and nitrogen from the cathode, the area of the electrolyte membrane, the number of cells constituting the fuel cell stack, and characteristics of the gas channel. The amount of permeation of water and nitrogen from the cathode changes with the properties of the electrolyte membrane and the gas diffusion layer. The characteristics of the gas channel affect the diffusion of the gas passing through the channel.

For example, a fuel cell system of dead end type that has a stack of cells having a fluorine-based solid polymer electrolyte membrane having a thickness of 45 μm manufactured by W.L. Gore and Associates, Inc. was operated for one minute under the condition that the pressure of hydrogen supplied to the anode was set at 120 kPa. Then, the loss of power was 2.50 mW/cm²·cell. When the same fuel cell system was operated for one minute under the condition that the pressure of hydrogen was set at 150 kPa, the loss of power was 1.39 mW/cm²·cell.

In FIG. 3, the abscissa indicates time (minute) and the ordinate indicates total loss (W*minute) of the power due to the decrease in voltage of the fuel cell. Since the amount of water and nitrogen accumulated in the channel increases with time, the decrease in voltage increases with time. If the pressure of hydrogen supplied to the anode is low, the decrease in voltage further increases. Thus, as shown in FIG. 3, the lower the hydrogen pressure, the more sharply the loss of power increases with time, and therefore, the higher the total loss of power becomes.

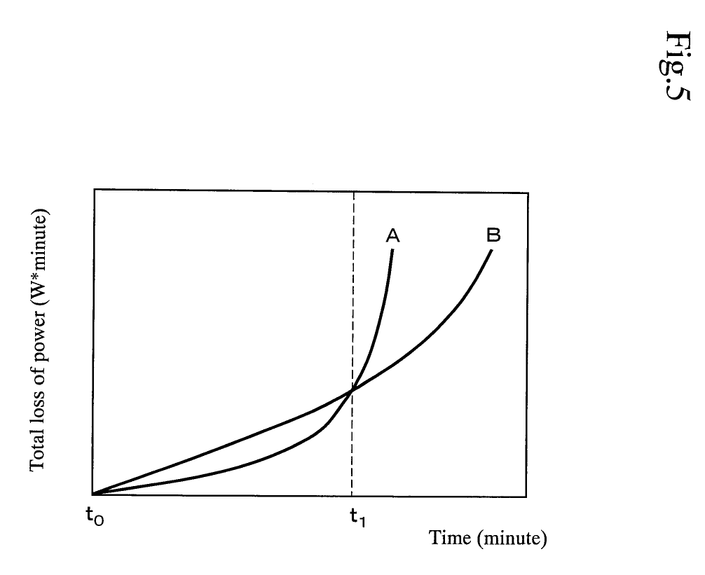

FIG. 4 is a graph schematically showing temporal changes in total loss of power due to permeation of hydrogen through the electrolyte membrane.

Under the condition that the pressure of hydrogen is kept constant, the amount of hydrogen that permeates through the electrolyte membrane is determined by the properties of the electrolyte membrane, the area of the electrolyte membrane, and the number of cells constituting the fuel cell stack. For example, in case that a fuel cell system of dead end type that has a stack of cells having a fluorine-based solid polymer electrolyte membrane having a thickness of 45 μm manufactured by W.L. Gore and Associates, Inc. is operated under the condition that the pressure of hydrogen supplied to the anode is set at 120 kPa, then, the loss of power per unit time is 1.94 mW/cm²·cell.

In FIG. 4, the abscissa indicates time (minute) and the ordinate indicates total loss (W*minute) of the power due to permeation of hydrogen through the electrolyte membrane. As the pressure of hydrogen supplied to the anode increases, the amount of permeation of hydrogen increases, and therefore, the loss of power per unit time also increases. Thus, as shown in FIG. 4, as the hydrogen pressure increases, the total loss of power increases.

In this embodiment, the pressure of hydrogen supplied to the anode and the timing of raising the pressure are determined taking into account both FIGS. 3 and 4.

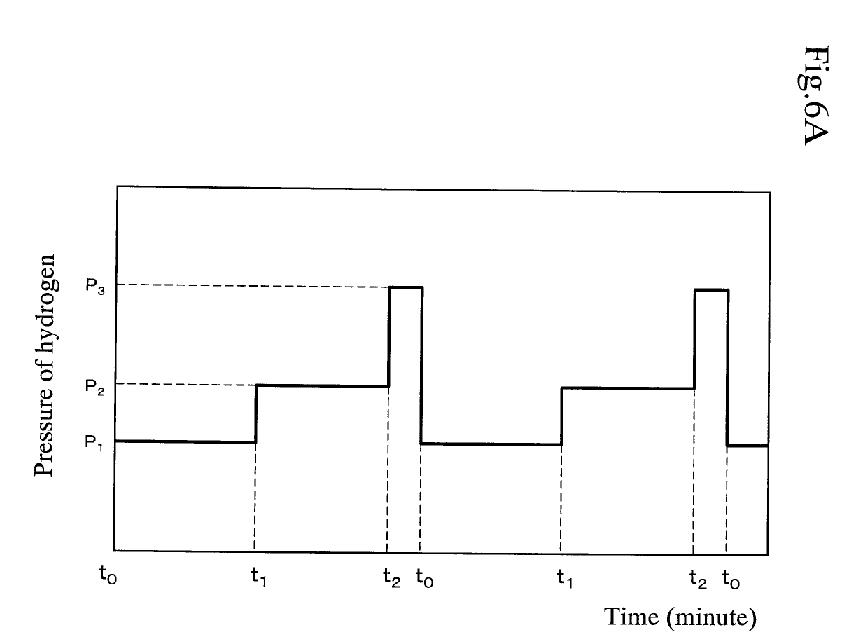

FIG. 5 is a graph showing temporal changes in total loss of power due to the decrease in voltage and the permeation of hydrogen. A first curve (A) shows the sum of the changes in the case where the hydrogen pressure is P₁ shown in FIGS. 3 and 4. A second curve (B) shows the sum of the changes in the case where the hydrogen pressure is P₂ shown in FIGS. 3 and 4. Until a time t₁, the total loss of power shown by the curve (A) is lower than the curve (B). However, from the time t₁, it is understood that the total loss of power shown by the curve (B) is lower than the curve (A).

Thus, in this embodiment, the pressure of hydrogen supplied to the anode is set at P₁ at a time t₀, and then the pressure of hydrogen is changed to P₂ (P₁<P₂) at the time t₁. Supposing that the sum of the total loss of power due to the decrease in voltage of the fuel cell and the total loss of power due to permeation of hydrogen through the electrolyte membrane when the pressure is P₁ is denoted by X₁, and the sum of the total loss of power due to the decrease in voltage of the fuel cell and the total loss of power due to permeation of hydrogen through the electrolyte membrane when the pressure is P₂ is denoted by X₂, when the time t₁ elapses, the pressure is preferably changed so that the following relation is filled.

X₂<X₁

In the fuel cell system 1 shown in FIG. 1, the fuel cell 2 operates with the purge valve 8 closed. When a predetermined time elapses from the start of operation, the purge valve 8 is opened to carry out purging. The time to described above is a point in time immediately after the purging is carried out. Purging is carried out when the fuel cell 2 is activated, so that the time t₀ may be the time of activation of the fuel cell 2.

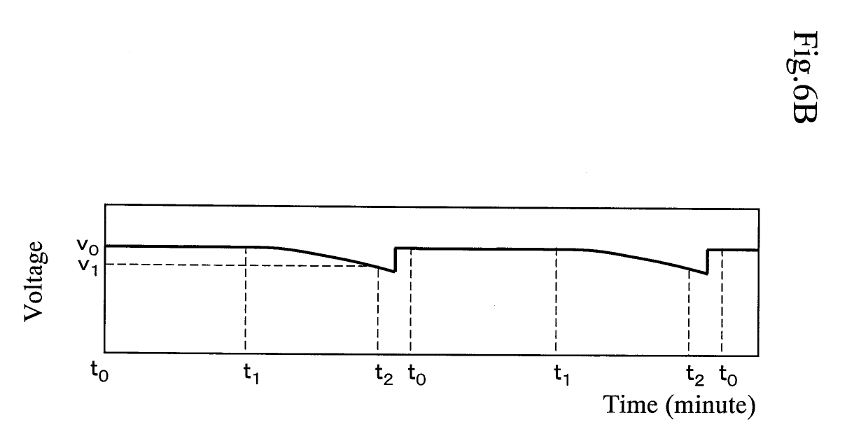

FIG. 6(a) shows a temporal change in pressure of hydrogen supplied to the anode in this embodiment. FIG. 6(b) shows a change in voltage of the fuel cell when the pressure of hydrogen changes as shown in FIG. 6(a).

As shown in FIG. 6(a), the pressure of hydrogen supplied to the anode is set at P₁ from the time to the time t₁. The pressure P₁ has to be higher than the pressure drop in the channel through which hydrogen passes through and preferably allows only a minimum amount of hydrogen required for the fuel cell 2 to generate power to be supplied to the anode. With such a pressure, the amount of hydrogen that permeates through the electrolyte membrane to the cathode side can be minimized.

Referring to FIG. 6(a), at the time t₁, the pressure of hydrogen is changed from P₁ to P₂ (P₁<P₂). As shown in FIG. 6(b), the voltage of the fuel cell decreases with time. However, the decrease in voltage can be reduced by raising the pressure of hydrogen supplied to the anode.

By changing the pressure of hydrogen supplied to the anode from P₁ to P₂ in this way, the fuel cell can be operated while reducing the total loss of power due to the decrease in voltage and the permeation of hydrogen. In the example shown in FIG. 1, the pressure of hydrogen can be changed by changing the opening of the hydrogen pressure regulating valve 7 under the control of the pressure controlling means 9.

As the fuel cell is operated with the hydrogen pressure kept at P₂, the amount of water and nitrogen accumulated in the gas channel on the anode side gradually increases. Thus, purging is carried out at an appropriate point in time. The water, nitrogen and the like accumulated in the gas channel on the anode side can be discharged by purging.

According to the technique disclosed in the Patent Document 1, the purge valve is opened for a predetermined time when it is determined that purging is necessary. By this operation, water and components other than hydrogen accumulated in the gas channel can be discharged, and the effect of these components can be reduced to prevent degradation of the characteristics of the fuel cell.

However, there remains a problem that, if hydrogen is also discharged by the purging, and the hydrogen utilization decreases. In addition, there is a problem that, if water and nitrogen are not adequately discharged in each purging, the partial pressure of hydrogen decreases faster, the voltage of the fuel cell also decreases faster, and as a result, the intervals of purging gradually become shorter.

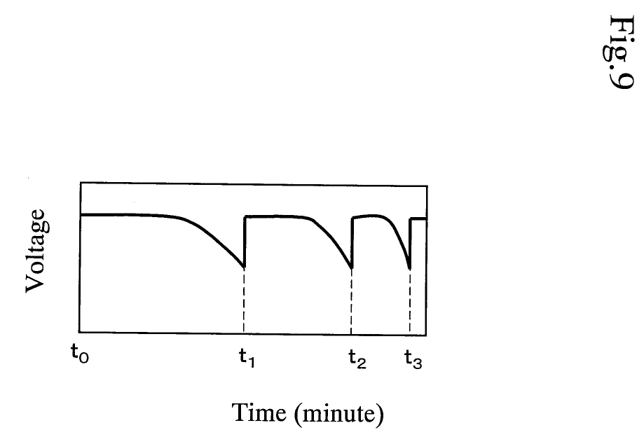

FIG. 9 is a graph showing a temporal change in voltage of a fuel cell in a conventional fuel cell system. If the pressure of hydrogen is not enough when purging is carried out, water and nitrogen remain in the gas channel, causing a faster decrease in partial pressure of hydrogen. Therefore, as shown in FIG. 9, the decrease in voltage becomes faster with time. Thus, even if purging is carried out when a time t₁ elapses from a time to, the next purging has to be carried out when a time t₂ (t₁>t₂) elapses from the time t₁, and the next purging has to be carried out when a time t₃ (t₂>t₃) elapses from the time t₂. In this way, if the pressure of hydrogen is not enough when purging is carried out, the intervals of purging gradually become shorter.

Thus, in the embodiment 1, the problem with purging described above is solved as described below.

Specifically, in FIG. 6, at a time t₂, the pressure of hydrogen is changed to P₃, and the purge valve 8 is opened. The pressure P₃ is higher than the pressure P₂ and is enough to discharge water and impurity gas, such as nitrogen. The value of the pressure P₃ can be determined without taking into account the total loss of power due to the decrease in voltage and the permeation of hydrogen. If the pressure P₃ is determined in this way, the pressure of hydrogen at the time of purging increases, so that the hydrogen utilization decreases, and the power generation efficiency of the fuel cell temporarily decreases. However, in total, the power generation efficiency is improved because the efficiency of discharge of water and nitrogen increases.

By carrying out purging at the pressure P₃, water and nitrogen can be adequately discharged from the gas channel on the anode side. Therefore, it is possible to prevent water and nitrogen from remaining in the gas channel to cause the partial pressure of hydrogen to decrease faster. In other words, it is possible to prevent the voltage of the fuel cell from decreasing faster. Thus, it is possible to prevent the intervals of purging from becoming shorter.

The time t₂ is a time at which the concentrations of water and nitrogen accumulated in the channel 10 reach a predetermined value. The concentrations of water and nitrogen can be estimated from the operating conditions of the fuel cell 2.

Purging is necessary when the concentrations of water and nitrogen increase and, as a result, the voltage of the fuel cell decreases to a predetermined value. Therefore, the “time at which the concentrations of water and nitrogen accumulated in the channel 10 reach a predetermined value” can be expressed also as the “time at which the voltage of the fuel cell 2 decreases to a predetermined value”. In the example shown in FIG. 6(a), the time is the time t₂ at which the voltage decreasing from v₀ reaches v₁.

The purge valve 8 is closed when an enough time to discharge water and nitrogen from the channel 10 elapses. Then, the fuel cell system 1 is operated with the channel for the fuel off-gas closed. The voltage of the fuel cell 2 is restored to v₀, which is the initially set value of the voltage, or a value close to the value.

After that, the pressure of hydrogen supplied to the anode is changed back to P₁, and the operation described above is repeated with the time of change of the hydrogen pressure designated as t₀.

As described above, in the fuel cell system according to this embodiment, supposing that the time to is a point in time immediately after purging, the pressure of the fuel gas is set at P₁ from the time to the time t₁, and the pressure of the fuel gas is changed to P₂, which is higher than P₁, after the time t₁. Therefore, the fuel cell can be operated while reducing the total loss of power of the fuel cell, which is determined from the amount of hydrogen that permeates through the electrolyte membrane and the decrease in voltage of the fuel cell measured with voltage measuring means. Thus, the fuel cell system can generates power with high efficiency.

In this embodiment, supposing that the sum of the total loss of power due to the decrease in voltage of the fuel cell and the total loss of power due to permeation of the fuel gas through the electrolyte membrane when the pressure is P₁ is denoted by X₁, and the sum of the total loss of power due to the decrease in voltage of the fuel cell and the total loss of power due to permeation of the fuel gas through the electrolyte membrane when the pressure is P₂ is denoted by X₂, after the time t₁ elapses, the following relation is preferably filled.

X₂<X₁

In addition, in this embodiment, in the case where the pressure P₁ is a pressure that allows a minimum amount of fuel gas required for the fuel cell to generate power to be supplied to the anode, the time t₁ preferably corresponds to a time coordinate at which the first curve, which shows the sum of the change in total loss of power due to the decrease in voltage of the fuel cell and the change in total loss of power due to permeation of the fuel gas through the electrolyte membrane when the pressure is P₁, and the second curve, which shows the sum of the change in total loss of power due to the decrease in voltage of the fuel gas and the change in total loss of power due to permeation of the fuel gas through the electrolyte membrane when the pressure is P₂, intersect with each other in the graph shown in the coordinate system whose coordinate axes indicate time and total loss of the power generated by the fuel cell.

The present invention is not limited to the each embodiment described above, and various variations are possible without departing from the spirit of the present invention.

For example, the pressure controlling means for controlling the pressure of hydrogen can increase the pressure of hydrogen stepwise in the period from the time t₁ to the time t₂ as shown in FIG. 6(a). However, the pressure controlling means can also increase the pressure of hydrogen continuously.

In the example shown in FIG. 6(a) described above, the pressure of hydrogen is changed in two steps from P₁ to P₂ and then from P₂ to P₃. However, the present invention is not limited thereto. For example, before purging is carried out, the pressure of hydrogen is not necessarily changed in one step from P₁ to P₂ and can be changed in a plurality of steps, such as in two steps and in three steps. Alternatively, the pressure of hydrogen can be changed in a continuous manner, rather than in such a discontinuous manner.

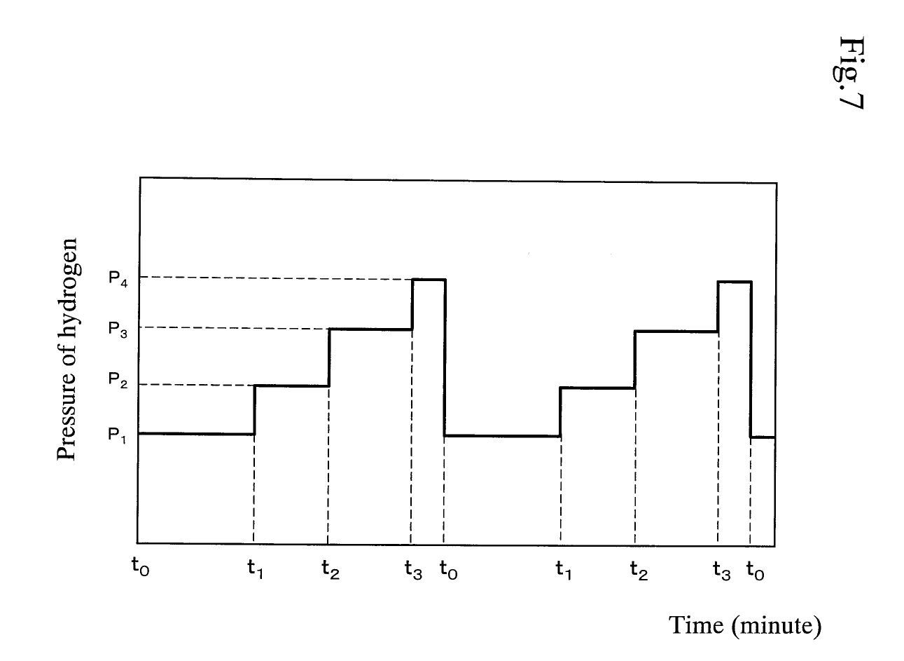

FIG. 7 shows an example in which the pressure of hydrogen is changed in two steps before purging. In this example, supposing that a time to is a point in time immediately after purging, the pressure of hydrogen supplied to the anode is set at P₁ from the time to a time t₁. Then, at the time t₁, the pressure of hydrogen is changed from P₁ to P₂ (P₁<P₂). Furthermore, at a time t₂, the pressure of hydrogen is changed from P₂ to P₃ (P₂<P₃). Then, at a time t₃, the pressure of hydrogen is changed to P₄, and the purge valve is opened to carry out purging. The pressure P₄ is higher than the pressure P₃ and is high enough to discharge water and nitrogen. When a time enough to discharge water and nitrogen elapses, the purge valve is closed. After that, the pressure of hydrogen is set at P₁ again, and the process described above is repeated.

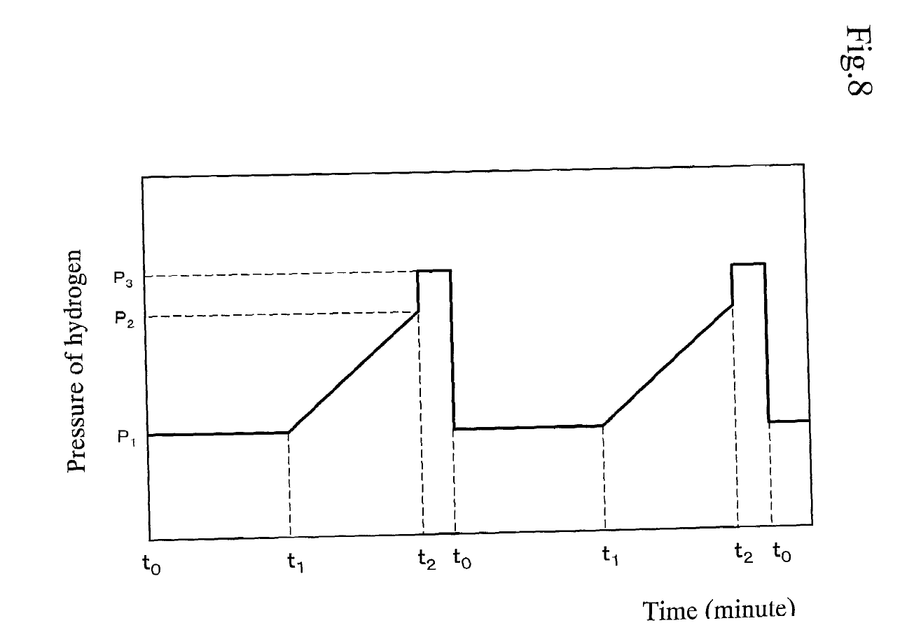

FIG. 8 shows an example in which the pressure of hydrogen is continuously changed before purging is carried out. In this example, supposing that a time to is a point in time immediately after purging, the pressure of hydrogen supplied to the anode is set at P₁ from the time to a time t₁. Then, from the time t₁ to a time t₂, the pressure of hydrogen is increased linearly from P₁ to P₂. Then, at the time t₂, the pressure of hydrogen is changed from P₂ to P₃, and the purge valve is opened to carry out purging. The pressure P₃ is higher than the pressure P₂ and is high enough to discharge water and nitrogen. When a time enough to discharge water and nitrogen elapses, the purge valve is closed. After that, the pressure of hydrogen is set at P₁ again, and the process described above is repeated.

As described above, if the number of changes of the pressure of hydrogen is changed or the pressure of hydrogen is changed continuously, the fuel cell system can be operated while controlling the hydrogen pressure more precisely so that the total loss of the power of the fuel cell is reduced. Therefore, in the examples shown in FIGS. 7 and 8, the fuel cell system can generate power with higher efficiency than in the example shown in FIG. 6(a).

In the embodiment described above, the fuel gas supplied to the anode is hydrogen. However, the present invention is not limited thereto. For example, as a source of hydrogen supplied to the anode, a reformed gas generated by reformation of a hydrocarbon compound can be used.

### Embodiment 2

In the fuel cell system according to the embodiment 1, the fuel cell 2 is operated in the state where a downstream part of the gas channel on the anode side (a downstream part of the channel for the fuel off-gas) is closed (in a closed mode) for a predetermined time, and when the predetermined time elapses, purging of the gas channel is carried out. An embodiment 2 differs from the embodiment 1 in that the fuel cell 2 is operated without purging (the system according to the embodiment 2 will be referred also as complete dead end fuel cell system hereinafter).

The system according to the embodiment 2 has the same structure as the system shown in FIG. 1 except that the purge valve 8 and the channel 10 are not provided, and the downstream part of the gas channel on the anode side of the fuel cell 2 is closed. Therefore, the structure of the system according to the embodiment 2 is not particularly shown, and the same parts as those of the system according to the embodiment 1 are denoted by the same reference numerals, and descriptions thereof will be omitted or simplified in the following.

The complete dead end fuel cell system is a system that permits an impurity material (nitrogen or the like) that does not contribute to power generation to remain in the gas channel on the side of the anode 16 of the fuel cell 2. In the following, among other impurity materials, nitrogen will be particularly described. However, this is not intended to exclude other impurity materials than nitrogen from the scope of the present invention.

When the partial pressure of nitrogen in the gas channel on the side of the anode 16 increases to some level, the partial pressure of nitrogen becomes equal to the partial pressure of nitrogen in the gas channel on the side of the cathode 17. In this case, the partial pressure of nitrogen in the gas channel on the anode side does not further increase. The complete dead end fuel cell system is a system that operates the fuel cell 2 in such an equilibrium state in which the partial pressures of nitrogen on the anode and cathode sides are equal to each other.

In the following, pressure control according to the embodiment will be described. Also in the complete dead end system according to the embodiment 2, the relationships shown in FIGS. 3 and 4 described in the embodiment 1 hold. That is, as shown in FIG. 3, the lower the pressure of hydrogen at the anode, the smaller the effect of the decrease in voltage due to the impurity material in the channel becomes. In addition, as shown in FIG. 4, the higher the pressure of hydrogen at the anode, the larger the amount of permeation of hydrogen becomes. Therefore, in the embodiment 2, similarly, the pressure of hydrogen at the anode is controlled taking these facts into account.

Specifically, in the complete dead end fuel cell system, there is a tendency that the partial pressure of nitrogen in the gas channel on the anode side becomes lower when the fuel cell 2 is activated. Thus, the pressure of the fuel gas on the anode side is set at a lower pressure P₁ to reduce the amount of permeation of hydrogen to the side of the cathode 17 through the electrolyte membrane. In this way, as in the embodiment 1, an excessive amount of permeation of hydrogen can be prevented, and the hydrogen utilization can be improved.

As the partial pressure of nitrogen increases, the pressure of the fuel gas on the anode side is increased to P₂ (P₁<P₂). Then, after the pressure is increased, power generation is continued in the equilibrium state described above in which the partial pressures of nitrogen on the anode and cathode sides are equal to each other. Thus, as in the embodiment 1, a decrease in voltage due to excessive accumulation of impurity materials, such as nitrogen, can be reduced. Specifically, such pressure control can be achieved by controlling the pressure of the fuel gas in the same manner as in the embodiment 1, supposing that the time of start of operation of the fuel cell 2 designated as time t₀. Times t₁, t₂ and t₃ can also be designated in the same manner as in the embodiment 1.

With such a configuration, the fuel cell system can generate power with high efficiency as with the system according to the embodiment 1.

In the embodiments 2, variations similar to those in the embodiment 1 are possible. Specifically, the pressure controlling method based on the total losses of power X₁ and X₂ for the pressures P₁ and P₂ described in the embodiment 1 can be used in the embodiment 2. Furthermore, the timing of pressure change can be set at a time coordinate at which a first curve and a second curve, which show changes in total loss of power for the pressures P₁ and P₂, intersect with each other. Furthermore, various pressure controlling methods described in the embodiment 1, such as the method of changing the pressure of hydrogen at the anode continuously or stepwise, can be used for pressure control in the embodiment 2.

### Embodiment 3

According to the present invention, a combination of the systems according to the embodiments 1 and 2 is also possible. For example, the present invention can provide a fuel cell system in which, when the fuel cell 2 is operated in a predetermined low-load region, power generation is carried out with the downstream part of the gas channel on the anode side closed (embodiment 2), and when the fuel cell 2 is operated in a predetermined high-load region, power generation is carried out while appropriately purging impurity materials in the gas channel on the anode side (embodiment 1). In this case, when the fuel cell system operates in the complete dead end mode, a point in time at which power generation with the gas channel on the anode side closed is started can be designated as to, and when the fuel cell system operates in the mode using purging, a point in time immediately after purging can be designated as t₀.

1. A fuel cell system, comprising:
a fuel cell that has an electrolyte membrane, an anode disposed on one surface of the electrolyte membrane, and a cathode disposed on the other surface of the electrolyte membrane and is supplied with a fuel gas at the anode and with an oxidant gas at the cathode to generate an electromotive force; and
pressure controlling means that controls the pressure of said fuel gas,
wherein the fuel cell system has a closed mode in which said fuel cell is operated in a state where a channel for a fuel off-gas discharged from said fuel cell is closed, and
said pressure controlling means sets the pressure of said fuel gas at P₁ from the start of operation in said closed mode until a time t₁ elapses and sets the pressure of said fuel gas at P₂ (P₁<P₂) after the time t₁ elapses.

2. The fuel cell system according to claim 1, further comprising:
purge means that opens the channel for said fuel off-gas to purge the channel,
wherein when said purge means carries out purging, it is determined that said closed mode starts immediately after the purging.

3. The fuel cell system according to claim 1, wherein said pressure controlling means increases the pressure P₂ stepwise.

4. The fuel cell system according to claim 1, wherein said pressure controlling means increases the pressure P₂ continuously.

5. The fuel cell system according to claim 1, wherein, supposing that the sum of total loss of power generated by said fuel cell due to a decrease in voltage of said fuel cell and said total loss of power due to permeation of said fuel gas through said electrolyte membrane when pressure is P₁ is designated as X₁, and the sum of said total loss of power due to a decrease in voltage of said fuel cell and said total loss of power due to permeation of said fuel gas through said electrolyte membrane when pressure is P₂ is designated as X₂, a relation:
X₂<X₁
is filled after the time t₁ elapses.

6. The fuel cell system according to claim 1, wherein the pressure P₁ is a pressure that allows a minimum amount of fuel gas required for said fuel cell to generate power to be supplied to said anode, and
the time t₁ corresponds to a time coordinate in a graph whose coordinate axes are time and total loss of power generated by said fuel cell at which a first curve, which shows the sum of a change in said total loss of power due to a decrease in voltage of said fuel cell and a change in said total loss of power due to permeation of said fuel gas through said electrolyte membrane when pressure is P₁, and a second curve, which shows the sum of a change in said total loss of power due to a decrease in voltage of said fuel cell and a change in said total loss of power due to permeation of said fuel gas through said electrolyte membrane when pressure is P₂, intersect with each other.

7. The fuel cell system according to claim 2, wherein, when a time t₂ (t₁<t₂) elapses, the pressure of said fuel gas is set at P₃ (P₂<P₃), and the channel for said fuel off-gas is opened to carry out purging.

8. The fuel cell system according to claim 7, wherein the pressure P₃ is a pressure that is high enough to adequately discharge an impurity gas accumulated in the channel for said fuel off-gas.

9. A fuel cell system, comprising:
a fuel cell that has an electrolyte membrane, an anode disposed on one surface of the electrolyte membrane, and a cathode disposed on the other surface of the electrolyte membrane and is supplied with a fuel gas at the anode and with an oxidant gas at the cathode to generate an electromotive force; and
pressure controlling unit that controls the pressure of said fuel gas,
wherein the fuel cell system has a closed mode in which said fuel cell is operated in a state where a channel for a fuel off-gas discharged from said fuel cell is closed, and
said pressure controlling unit sets the pressure of said fuel gas at P₁ from the start of operation in said closed mode until a time t₁ elapses and sets the pressure of said fuel gas at P₂ (P₁<P₂) after the time t₁ elapses.
